(19) United States
(12) Patent Application Publication
(10) Pub. No.: US 2021/0161329 A1
(43) Pub. Date: Jun. 3, 2021

(54) COOKING APPARATUS AND CONTROL METHOD THEREOF

(71) Applicant: LG ELECTRONICS INC., Seoul (KR)

(72) Inventor: SUNG-IL KIM, Seoul (KR)

(73) Assignee: LG ELECTRONICS INC., Seoul (KR)

(21) Appl. No.: 16/786,763

(22) Filed: Feb. 10, 2020

(30) Foreign Application Priority Data
Nov. 28, 2019 (KR) 10-2019-0155705

(51) Int. Cl. A47J 36/32; A47J 27/00; A23L 5/10

(52) U.S. Cl. CPC A47J 36/32; A23V 2002/00; A23L 5/15; A47J 27/004

(57) ABSTRACT

A cooking apparatus and a cooking apparatus control method are disclosed. The cooking apparatus and cooking apparatus control method analyze information on a cooking target using image analysis artificial intelligence (AI) technology, and perform cooking based on analyzed cooking information on the cooking target. In particular, the intensity, time, or the like of heat emitted toward the cooking target positioned in a cooking apparatus is controlled using an artificial intelligence artificial intelligence (AI) model that performs machine learning (ML) through a 5G network. In addition, the intensity, time, or the like of heat emitted toward the cooking target is controlled depending on a cooking state of a container accommodating the cooking target, so as to prevent the cooking target from being damaged.

### CROSS-REFERENCE TO RELATED APPLICATION

This present application claims the benefit of priority to Korean Patent Application No. 10-2019-0155705, entitled “Cooking Apparatus and Control Method thereof” filed on Nov. 28, 2019, in the Korean Intellectual Property Office, the entire disclosure of which is incorporated herein by reference.

### BACKGROUND

### 1. Technical Field

The present disclosure relates to an apparatus and method of controlling a heater, configured to determine a position of a cooking target using image analysis artificial intelligence (AI) technology and automatically cook the cooking target using an appropriate automatic cooking neural network depending on, for example, the position of the cooking target or a cooking time of the cooking target.

### 2. Description of Related Art

The following description is only for the purpose of providing background information related to embodiments of the present disclosure, and the contents to be described do not necessarily constitute related art.

When foods are cooked using a cooking apparatus such as an oven, a microwave, or an air fryer, a user directly inputs, for example, a cooking type, a cooking method, and setting information for cooking. However, since it is complicated to set a cooking apparatus according to diverse cooking methods, and since characteristics such as area or thickness may be different even for the same cooking target, it may not always be appropriate to use a cooking apparatus according to a standardized recipe.

In particular, there has been increasing interest in technologies for automatic cooking according to the intensity or time of a heater for heating a cooking target, or a preference of a food consumer, depending on the cooking state (for example, a semi-cooked state, a frozen state, or a non-cooked state) of the cooking target, a position of the cooking target inputted to the cooking apparatus, or the like.

As related art, Korean Patent Application Publication No. 10-2019-0038184 discloses a technology related to a “Method and apparatus for auto cooking”. The aforementioned document discloses a technology for automatically controlling a cooking procedure of a cooking target by selectively emitting light in different wavelength bands to the cooking target, and acquiring and identifying information on the cooking target based on a reflected image.

The aforementioned document discloses a cooking apparatus that uses a machine learning algorithm, but does not disclose a technology for appropriate cooking depending on a position of the cooking target inputted to the cooking apparatus, or a technology for automatic cooking according to a preference of a food consumer of a product such as a prepared food.

In addition, Korean Patent Application Publication No. 10-2019-0084556 discloses an “Electronic Device of Determining timeline about Cooking task”, which relates to a technology for automatic cooking according to a recipe of a specific food.

The aforementioned document discloses a technology for updating a timeline of a cooking apparatus depending on a changed setting value of the cooking apparatus when the setting value is changed, and displaying the updated timeline, but does not disclose a technology for controlling the intensity or time of a heater depending on a position of a cooking target inputted to the cooking apparatus or adjusting a cooking time according to a preference of a food consumer.

To address the aforementioned limitations, there is a need for a solution for appropriate cooking of a cooking target by controlling a cooking apparatus through a neural network model trained using various methods.

The background art described above may be technical information retained by the present inventors in order to derive the present disclosure or acquired by the present inventors along the process of deriving the present disclosure, and thus is not necessarily a known art disclosed to the general public before the filing of the present application.

### SUMMARY OF THE INVENTION

An aspect of the present disclosure is to analyze a position of a cooking target disposed in a cooking apparatus using image analysis artificial intelligence (AI) technology, and to appropriately cook a cooking target based on the analysis result by controlling, for example, a direction of a heater for emitting heat toward a cooking target or a time of emitting heat by the heater.

Another aspect of the present disclosure is to control, for example, the intensity or time of heat emitted toward the cooking target according to a cooking state of a container accommodating the cooking target, so as to prevent the cooking target from being excessively cooked.

Still another aspect of the present disclosure is to recognize a user who uses a cooking apparatus, and cook the cooking target according to a preference of the user.

Aspects of the present disclosure are not limited to the above-mentioned aspects, and other aspects and advantages of the present disclosure, which are not mentioned, will be understood through the following description, and will become apparent from the embodiments of the present disclosure. It is also to be understood that the aspects of the present disclosure may be realized by means and combinations thereof set forth in claims.

A cooking apparatus using image analysis artificial intelligence (AI) technology according to the present disclosure may include a main body that forms an exterior of the cooking apparatus, a heater configured to cook a cooking target in the main body, a camera configured to photograph the cooking target, and a processor configured to communicate with the camera and the heater to control the cooking apparatus.

In this case, the processor may be configured to recognize a position of the cooking target photographed by the camera in the main body, and to control the heater depending on the position of the cooking target.

A cooking apparatus control method using image analysis artificial intelligence (AI) technology according to an embodiment of the present disclosure may include photographing a cooking target positioned in a main body that forms an exterior of the cooking apparatus, recognizing a position of the photographed cooking target in the main body, and then controlling a heater disposed in the main body to heat the cooking target depending on the position of the cooking target.

Thus, even if the cooking target is not positioned at a position for cooking a food in a cooking apparatus, the position of the cooking target may be determined, and a direction of a heater for cooking the cooking target may be controlled to emit heat to an overall portion of the cooking target, thereby uniformly cooking the cooking target.

Other aspects and features than those described above will become apparent from the following drawings, claims, and detailed description of the present disclosure.

According to embodiments of the present disclosure, a cooking apparatus and a cooking apparatus control method may analyze a position of a cooking target using image analysis AI technology, and may control a direction of a heater for heating the cooking target depending on the analyzed position of the cooking target.

In particular, during cooking of the cooking target, even if the position of the cooking target in the cooking apparatus is not a correct position, the cooking target may be appropriately cooked. In detail, the position of the cooking target may not be positioned at a cooking position inside the cooking apparatus. In this case, after the position of the cooking target is determined, the direction of the heater for cooking the cooking target may be controlled to emit heat emitted from the heater to an overall portion of the cooking target, and thus the cooking target may be uniformly cooked.

According to the embodiments of the present disclosure, the cooking target may be classified into a prepared food (a convenience food and a meal kit) and an unprocessed cooking target. Here, in the case of the prepared food, a recipe of a product may be extracted through a QR code, a bar code, or the like loaded on a product packaging, and the product may be cooked based on the extracted recipe of the product.

In addition, the heater may be controlled through the state of the cooking target photographed by a camera during a procedure of driving the cooking apparatus to cook the cooking target. In detail, the cooking target may be cooked by the heater for heating the cooking target by the cooking apparatus. In this case, when the cooking target contains moisture, if heat emitted from the heater is emitted to the cooking target for a predetermined time or greater or with a predetermined intensity or greater, the cooking target may boil. In this case, the container accommodating the cooking target may also be heated by heat generated inside the cooking apparatus, and the cooking target may spill over the container. When the container is heated, the container may lightly shake, and frictional sound may be generated between the container and an internal bottom surface of the cooking apparatus due to the shaking of the container. The cooking target may be determined to be boiling through the generated frictional sound, and when the cooking target is boiling, the intensity, time, or the like of the heater for heating the cooking target may be adjusted to prevent the cooking target from spilling over the container.

The effects of the present disclosure are not limited to those mentioned above, and other effects not mentioned can be clearly understood by those skilled in the art from the following description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a schematic diagram illustrating a cooking apparatus according to an embodiment of the present disclosure;

FIG. 2 is a diagram illustrating an environment for controlling a cooking apparatus according to an embodiment of the present disclosure;

FIGS. 3 and 4 are block diagrams for explaining a cooking apparatus and an environment for controlling the same according to an embodiment of the present disclosure;

FIG. 5 is a schematic diagram for explaining an energy direction controller of FIG. 3;

FIG. 6 is a block diagram of a server corresponding to a learning device of an AI model according to an embodiment of the present disclosure;

FIG. 7 is a diagram illustrating an example of recognition of a cooking target using an AI model according to an embodiment of the present disclosure;

FIG. 8 is a diagram illustrating an example of use of a cooking procedure according to an embodiment of the present disclosure;

FIG. 9 is a flowchart of a cooking apparatus control method according to an embodiment of the present disclosure;

FIG. 10 is a flowchart of data of a cooking apparatus control method according to an embodiment of the present disclosure;

FIG. 11 is a flowchart of a cooking apparatus control method according to another embodiment of the present disclosure;

FIG. 12 is a flowchart of data of a cooking apparatus control method according to another embodiment of the present disclosure; and

FIGS. 13 and 14 are flowcharts of data of a cooking apparatus control method according to another embodiment of the present disclosure.

### DETAILED DESCRIPTION

Hereinafter the embodiments disclosed in this specification will be described in detail with reference to the accompanying drawings. The present disclosure may be embodied in various different forms and is not limited to the embodiments set forth herein. Hereinafter in order to clearly describe the present disclosure, parts that are not directly related to the description are omitted. However, in implementing an apparatus or a system to which the spirit of the present disclosure is applied, it is not meant that such an omitted configuration is unnecessary. Further, like reference numerals refer to like elements throughout the specification.

In the following description, although the terms “first”, “second”, and the like may be used herein to describe various elements, these elements should not be limited by these terms. These terms may be only used to distinguish one element from another element. Also, in the following description, the articles “a,” “an,” and “the,” include plural referents unless the context clearly dictates otherwise.

In the following description, it will be understood that terms such as “comprise,” “include,” “have,” and the like are intended to specify the presence of stated feature, integer, step, operation, component, part or combination thereof, but do not preclude the presence or addition of one or more other features, integers, steps, operations, components, parts or combinations thereof.

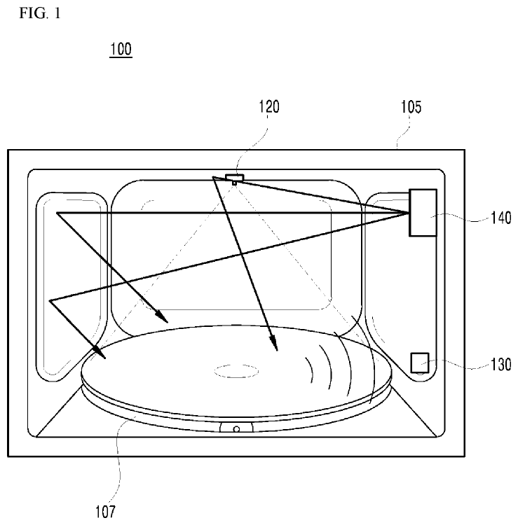

FIG. 1 is a schematic diagram illustrating a cooking apparatus according to an embodiment of the present disclosure.

Referring to FIG. 1, in a cooking apparatus control method for controlling the cooking apparatus according to an embodiment of the present disclosure, a cooking target may be photographed using a camera, and the captured image may be recognized. That is, a position of the cooking target may be analyzed using image analysis artificial intelligence (AI) technology. A disposed position of the analyzed cooking target in the cooking apparatus may deviate from a correct position of the cooking apparatus, in which the cooking target needs to be positioned. In this case, a direction, a time, or the like of a heater for heating and cooking the cooking target may be controlled to appropriately cook the cooking target.

In the cooking apparatus control method according to the present disclosure, the cooking target may be cooked by a heater for heating the cooking target in the cooking apparatus. In this case, when the cooking target contains moisture, if the heater heats the cooking target for a predetermined time or greater or heats and cooks the cooking target with a predetermined intensity or greater, the cooking target boils. In this case, a container that accommodates the cooking target therein may also be heated by heat generated inside the cooking apparatus, and the cooking target may spill over the container. When the container is heated, the container may lightly shake, and frictional sound may be generated between the container and an internal bottom surface of the cooking apparatus due to the shaking of the container. The cooking target may be determined to be boiling based on the generated frictional sound, and when the cooking target is boiling, the intensity and time of the heater for heating the cooking target may be adjusted to prevent the cooking target from spilling over the container.

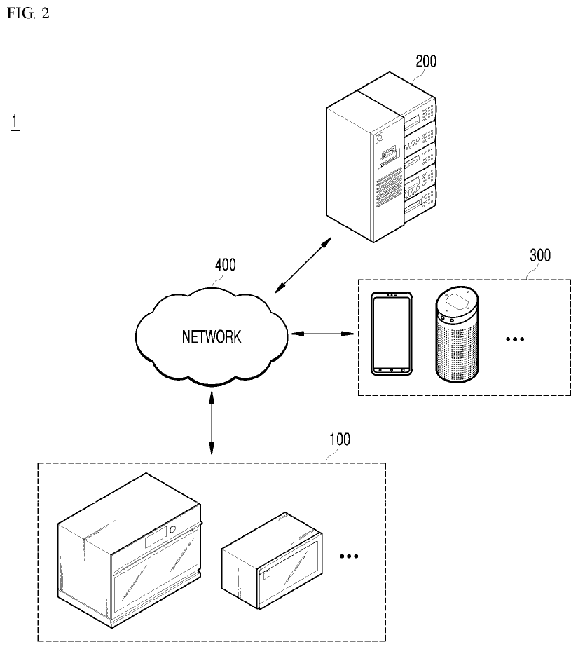

FIG. 2 is a diagram illustrating an environment for controlling a cooking apparatus according to an embodiment of the present disclosure.

Referring to FIG. 2, the environment for controlling a cooking apparatus 100 according to an embodiment of the present disclosure may be connected to equipment 300, the cooking apparatus 100, a server 200, and a network 400, and may communicate therewith.

The equipment 300 may include, for example, user equipment and an artificial intelligence (AI) assistant speaker including a photograph function. The AI assistant speaker may be a device that functions as a gateway in home automation, and may be implemented to be able to control various home appliances that use speech recognition.

In detail, the equipment 300 may be implemented as a fixed type device and a mobile device, such as a cellular phone, a projector, a cellular phone, a smartphone, a laptop computer, a digital broadcast terminal, a personal digital assistant (PDA), a portable multimedia player (PMP), a navigation device, a slate PC, a tablet PC, an ultrabook, a wearable device (for example, a smartwatch), a smart glass, a head mounted display (HMD), a set top box (STB), a DMB receiver, a radio, a washing machine, a refrigerator, a desk top computer, and a digital signage.

That is, the equipment 300 may be implemented in the form of various home appliances used in the home, and may also be applied to a fixed or mobile robot.

The cooking apparatus 100 may cook a cooking target according to a recipe that is directly inputted by a user who uses the cooking apparatus 100, or alternatively, may be an embedded system type apparatus and may cook the cooking target according to a cooking instruction received using a wireless communication function. For example, the cooking apparatus 100 may receive a cooking instruction through the equipment 300 and/or the server 200, and cook the cooking target according to the cooking instruction.

The cooking apparatus 100 may include an appliance, for example, an electric oven or an electric cooktop, and in the following embodiments of the present disclosure, the case in which the cooking apparatus 100 is a microwave will be exemplified.

The cooking apparatus 100 according to the present disclosure may include an artificial intelligence (AI) function capable of recognizing a cooking target, and when a recipe for cooking the recognized cooking target has been corrected by the user according to his or her preference, cooking the cooking target according to the corrected recipe of a user.

Although in the example described herein the cooking apparatus 100 is described as including the AI function, the present disclosure may also be implemented such that the server 200 includes the AI function and may control the cooking apparatus 100 depending on the cooking target.

In this case, a subject controlling the cooking apparatus 100 may be the user as described above, but the user may also control the cooking apparatus 100 through the equipment 300.

In relation to an AI model described with regard to an embodiment of the present disclosure, the server 200 may provide various services related to an AI model loaded in the cooking apparatus 100. The AI model will be described below in detail. The server 200 may provide various services required to recognize the cooking target.

The network 400 may be any appropriate communication network, including a wired or wireless network such as a local area network (LAN), a wide area network (WAN), the Internet, an intranet, and an extranet, and a mobile network such as a cellular network, a 3G network, an LTE network, a 5G network, a WiFi network, an ad hoc network, and a combination thereof.

The network 400 may include connection of network elements such as hubs, bridges, routers, switches, and gateways. The network 400 may include one or more connected networks, including a public network such as the Internet and a private network such as a secure corporate private network. For example, the network may include a multi-network environment. Access to the network 400 may be provided through one or more wired or wireless access networks.

The cooking apparatus 100 according to an embodiment of the present disclosure may transmit and receive data to and from the server 200, which is a learning device, through a 5G network. In particular, the equipment 300 and the AI assistant speaker may perform data-communication with a learning device using at least one of Enhanced Mobile Broadband (eMBB), ultra-reliable and low latency communications (URLLC), and massive machine type communications (mMTC) services through a 5G network.

eMBB is a mobile broadband service, and provides, for example, multimedia content and wireless data access. In addition, improved mobile services such as hotspots and broadband coverage for accommodating the rapidly growing mobile traffic may be provided via eMBB. Through a hotspot, high-volume traffic may be accommodated in an area where user mobility is low and user density is high. Through wideband coverage, a wide and stable wireless environment and user mobility can be secured.

The URLLC service defines requirements that are far more stringent than existing LTE in terms of reliability and transmission delay of data transmission and reception, and corresponds to a 5G service for production process automation in fields such as industrial fields, telemedicine, remote surgery, transportation, safety, and the like.

mMTC (massive machine-type communications) is a transmission delay-insensitive service that requires a relatively small amount of data transmission. mMTC enables a much larger number of terminals, such as sensors, than general mobile cellular phones to be simultaneously connected to a wireless access network. In this case, the communication module price of the terminal should be inexpensive, and there is a need for improved power efficiency and power saving technology capable of operating for years without battery replacement or recharging.

As described above, the cooking apparatus 100 according to an embodiment of the present disclosure may store or include various learning models such as a deep neural network or other types of machine learning models or technology including the same, to which AI technology capable of recognizing a cooking target and cooking the cooking target according to a corrected recipe of a user when a recipe for cooking the recognized cooking target has been corrected by the user according to his or her preference, is applied.

Artificial intelligence (AI) is an area of computer engineering science and information technology that studies methods to make computers mimic intelligent human behaviors such as reasoning, learning, self-improving, and the like, or how to make computers mimic such intelligent human behaviors.

In addition, AI does not exist on its own, but is rather directly or indirectly related to a number of other fields in computer science. In recent years, there have been numerous attempts to introduce an element of AI into various fields of information technology to solve problems in the respective fields.

Machine learning is an area of AI that includes the field of study that gives computers the capability to learn without being explicitly programmed.

Specifically, machine learning is a technology that investigates and builds systems, and algorithms for such systems, which are capable of learning, making predictions, and enhancing their own performance on the basis of experiential data. Machine learning algorithms, rather than only executing rigidly set static program commands, may be used to take an approach that builds models for deriving predictions and decisions from inputted data.

Numerous machine learning algorithms have been developed for data classification in machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

An ANN is a data processing system modeled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

Specifically, ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons.

In addition, the ANN may include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a previous layer.

ANNs may include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

In general, a single-layer neural network may include an input layer and an output layer.

In general, the multi-layer neural network may include an input layer, one or more hidden layers, and an output layer.

The input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. The input signals between the neurons are summed together after being multiplied by corresponding connection strengths (synaptic weights), and if this sum exceeds a threshold value of a corresponding neuron, the neuron can be activated and output an output value obtained through an activation function.

A deep neural network with a plurality of hidden layers between the input layer and the output layer may be a representative artificial neural network which enables deep learning, which is one machine learning technique.

An ANN may be trained using training data. Here, the training may refer to the process of determining parameters of the artificial neural network by using the training data, to perform tasks such as classification, regression analysis, and clustering of inputted data. Representative examples of parameters of the artificial neural network may include synaptic weights and biases applied to neurons.

An artificial neural network trained using training data can classify or cluster inputted data according to a pattern within the inputted data.

Throughout the present specification, an artificial neural network trained using training data may be referred to as a trained model.

Hereinbelow, a learning method of the artificial neural network will be described.

The learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a learning method that trains an artificial neural network to discover a pattern within given training data and perform classification by using the discovered pattern, rather than by using a correlation between given training data and labels corresponding to the given training data.

Examples of unsupervised learning may include clustering and independent component analysis.

Examples of artificial neural networks using unsupervised learning may include a generative adversarial network (GAN) and an autoencoder (AE).

GAN is a machine learning method in which two different Ms. a generator and a discriminator, improve performance through competing with each other.

The generator may be a model creating new data that generate new data based on true data.

The discriminator may be a model recognizing patterns in data that determines whether inputted data is from the true data or from the new data generated by the generator.

Furthermore, the generator may receive and learn data that has failed to fool the discriminator, while the discriminator may receive and learn data that has succeeded in fooling the discriminator. Accordingly, the generator may evolve so as to fool the discriminator as effectively as possible, while the discriminator may evolve so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. In this case, since the number of nodes in the output layer is greater than the number of nodes in the hidden layer, the dimensionality of the data increases, thus data decompression or decoding may be performed.

Furthermore, in the AE, the inputted data may be represented as hidden layer data as interneuron connection strengths are adjusted through learning. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves inferring the label of unlabeled training data, and then using this inferred label for learning. This technique may be used advantageously when the cost associated with the labeling process is high.

Reinforcement learning may be based on a theory that given the condition under which a reinforcement learning agent can determine what action to choose at each time instance, the agent may find an optimal path based on experience without reference to data.

Reinforcement learning may be performed primarily by a Markov decision process (MDP).

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

The hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. The one-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be used to minimize a cost function, and examples of such learning optimization algorithms may include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

The SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size. In the SGD, the momentum and NAG may also include methods that increase optimization accuracy by adjusting the step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network may include not only the structure and learning optimization algorithms of the artificial neural network but also the hyperparameters thereof. Therefore, in order to obtain a good learning model, it is important to choose a proper structure and learning algorithms for the artificial neural network, but also to choose proper hyperparameters.

In general, the hyperparameters may be set to various values experimentally to learn artificial neural networks, and may be set to optimal values that provide stable learning rate and accuracy of the learning result.

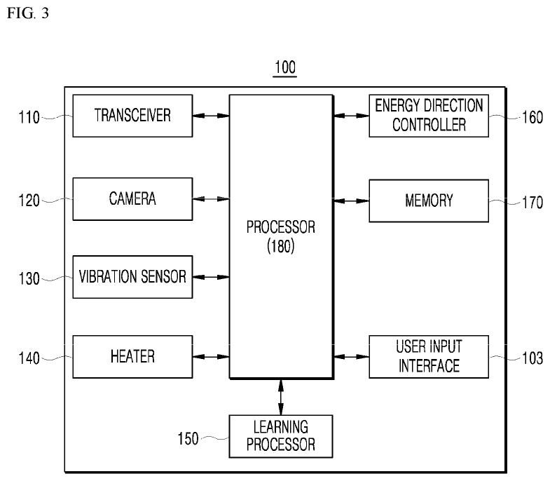

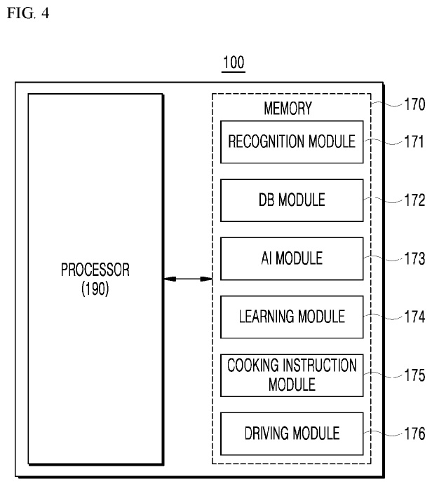

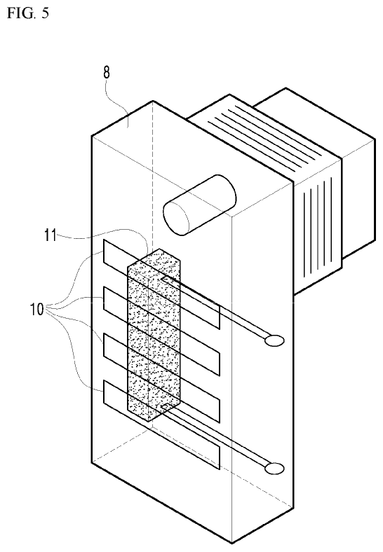

FIGS. 3 and 4 are block diagrams for explaining a cooking apparatus and an environment for controlling the same according to an embodiment of the present disclosure. FIG. 5 is a schematic diagram for explaining an energy direction controller of FIG. 3.

The cooking apparatus 100 according to an embodiment of the present disclosure may include a trained model loaded therein. The trained model may be embodied in hardware, software, or a combination of hardware and software, and when the trained model is partially or entirely embodied in software, one or more commands for configuring the trained model may be stored in a memory 170.

Referring to the drawings, the cooking apparatus 100 according to an embodiment of the present disclosure may include a main body 105, a transceiver 110, a camera 120, a vibration sensor 130, a display 109, a user input interface 103, the memory 170, a heater 140, and a processor 190.

The main body 105 (see FIG. 1) may form an exterior of the cooking apparatus 100, and may include a space for disposing a cooking target therein. A cradle 107 (see FIG. 1) for accommodating the cooking target may be loaded in the main body 105. The main body 105 may be formed in various shapes according to conditions of the embodied cooking apparatus 100, and the present disclosure is not limited by the shape of the main body 105.

The transceiver 110 may receive a cooking instruction from the cooking apparatus 100 or the server 200. The cooking apparatus 100 may be connected to the cooking apparatus 100, and may communicate therewith using the transceiver 110, for example, a short distance communication module such as Bluetooth™. The cooking apparatus 100 may be connected to the server 200 via the Internet using a wireless LAN, for example, a Wi-Fi module.

The camera 120 may be positioned inside or outside the cooking apparatus 100 to photograph the cooking target, and may acquire an input image for recognizing the photographed cooking target.

The camera 120 may acquire input data to be used when a control command for controlling the cooking apparatus 100 using training data for model training and a trained model is outputted.

The camera 120 may acquire unprocessed input data, and in this case, the processor 190 or a learning processor 150 may pre-process the acquired data to generate training data to be inputted to model training or pre-processed input data.

In this case, pre-processing of the input data may refer to extraction of an input feature from the input data.

The camera 120 may be used to input image information (or signals), an audio information (or signals), data, or information inputted from a user, and in order to input the image information, one or more cameras may be provided inside or outside the cooking apparatus 100.

When the cooking target is put into and disposed in cooking apparatus 100, the camera 120 may process a video or an image of the cooking target, acquired by an image sensor, into a frame. The processed frame may be displayed on the display 109 or may be stored in the memory 170.

The heater 140 may supply heat for cooking the cooking target positioned in the cooking apparatus 100. The heater 140 may be configured with any one of, for example, an electromagnetic wave or a hot wire, depending on the type of the cooking apparatus 100. As described above, a case in which the cooking apparatus 100 is a microwave is exemplified in an embodiment of the present disclosure, and thus, an example in which the heater 140 according to an embodiment of the present disclosure is embodied as an electromagnetic wave will be described.

In detail, the heater 140 may include an energy source for supplying energy for heating the cooking target and an energy direction controller 160 for adjusting a direction of energy emitted toward the cooking target from the energy source.

Here, the direction of the energy emitted toward the cooking target may be adjusted through the processor 190, which will be described below. In detail, the processor 190 may control the energy direction controller 160 to be directed toward the cooking target photographed by the camera 120.

As such, even if the cooking target is not positioned at a correct position in the main body 105, the energy direction controller 160 may be directed toward the cooking target and energy may be emitted toward the cooking target, the cooking target may be appropriately cooked.

The energy direction controller 160 for adjusting the direction of the heater 140 depending on a position of the cooking target will be described below with reference to FIG. 5.

The energy direction controller 160 may include a transmission path 8 including a plurality of slots 10 for transmitting electric energy or signals generated by the heater 140 to the cooking target, and a dielectric 11 that passes through the plurality of slots 10 to vary a phase of the slots 10.

In this case, each of the plurality of slots 10 may function as a slot antenna. The slot antenna may refer to an antenna formed by short-circuiting one end of a square type waveguide by a conductive plate and penetrating the conductive plate to form a groove in a perpendicular direction to an electric field. When the length of the groove of the slot antenna is half the wavelength, the slot antenna resonates like a half-wave antenna, and the center of the groove is the point at which the electric field is at maximum strength, that is, an antinode of a voltage, thereby achieving maximum emission efficiency. The slot antenna may be mainly used as a primary emitter of a parabolic antenna.

The transmission path 8 and a plurality of slots may operate as an array antenna. The array antenna may refer to an antenna configured by arranging several antenna devices to adjust phases of excitation current of the respective devices and to form main beams in a specific beam and the same phase through an antenna.

Based on this configuration, the dielectric 11 may be changed in position between the slot antennas to vary an emission pattern of the array antenna. That is, the dielectric 11 may determine a phase difference that is an electrical length between the slot antennas, and as the position of the dielectric 11 in the transmission path 8 is changed, the phase between the slots 10 may be changed. Thus, an entire emission pattern of the array antenna may be changed and a direction of the energy direction controller may be changed.

The vibration sensor 130 may measure an internal temperature of the cooking apparatus 100 during a cooking procedure.

The vibration sensor 130 may also sense frictional sound generated between the container accommodating the cooking target and the internal bottom surface of the cooking apparatus 100 during a cooking procedure. In detail, the cooking target may be cooked by the heater 140 for heating the cooking target in the cooking apparatus 100. In this case, when the cooking target contains moisture, if heat supplied from the heater 140 is emitted to the cooking target for a predetermined time or greater or is emitted to the cooking target with a predetermined intensity or greater, the cooking target boils. That is, moisture in the cooking target boils and is vaporized. In this case, the container that accommodates the cooking target therein may be heated by heat generated inside the cooking apparatus, and the cooking target may spill over the container. When the container is heated, the container may lightly shake, and frictional sound generated between the container and the internal bottom surface of the cooking apparatus due to the shaking of the container may be measured by the vibration sensor 130.

In summary, the state of the cooking target may be determined based on vibration in the main body 105, detected through the vibration sensor 130. For example, the container that accommodates the boiling cooking target may shake and the frictional sound may be generated between the container and the bottom surface of the main body 105. The vibration sensor 130 may detect the generated frictional sound, and the frictional sound may increase as the cooking target boils. In detail, when the level of the frictional sound is greater than a predetermined threshold value, the cooking target may be determined to be boiling, and in this case, the intensity of the heater 140 may be controlled to prevent the cooking target from additionally boiling and to prevent the cooking target from escaping the container and contaminating an internal part of the main body 105 due to the cooking target.

The learning processor 150 may train a model configured with an artificial neural network using data of the state of the cooking target, extracted through the camera 120.

For example, the learning processor 150 may determine the state of the cooking target, detected by the vibration sensor 130, using an LSTM recurrent neural network. The LSTM recurrent neural network may be a deep learning model for learning data that varies along with a time flow, such as time-series data, and may be an artificial neural network (ANN) configured via connection with a network at a reference time t and a next time t+1.

That is, the LSTM recurrent neural network may be a neural network trained to estimate the state of the cooking target along with a time-series variation of vibration generated during cooking of the cooking target.

The learning processor may determine a position of the cooking target positioned in the main body 105 through an image of the cooking target photographed through the camera 120.

To this end, the learning processor 150 may use a convolutional neural network, and the convolutional neural network may refer to a neural network trained to determine a position of the cooking target positioned in the main body 105 based on an image of the cooking target photographed inside the main body 105.

The learning processor 150 will now be described in detail. The learning processor 150 may repeatedly train an artificial neural network using the aforementioned various learning schemes to determine optimized model parameters of the artificial neural network.

Throughout this specification, an artificial neural network, parameters of which are determined via learning using training data, may be referred to as a learning model or a trained model.

In this case, the learning model may be used to infer a result value for new input data, not training data.

The learning processor 150 may be configured to receive, sort, store, and output information to be used for data mining, data analysis, intelligent decision, and a machine learning algorithm and technology.

The learning processor 150 may include one or more memories configured to store data that is received, detected, generated, pre-defined, or outputted by another component or device, or an apparatus that communicates with the equipment 300.

The learning processor 150 may include a memory that is integrated into the cooking apparatus 100. In some embodiments, an example in which the learning processor 150 is embodied using the memory 170 will be described.

In contrast, the learning processor 150 may also be embodied using an external memory that is directly coupled to the cooking apparatus 100 or a memory maintained in the server 200 that communicates with the cooking apparatus 100.

The learning processor 150 may be configured to store data in one or more databases in order to identify, index, categorize, manipulate, store, search, and output data for, generally, supervised or unsupervised learning, data mining, predictive analysis, or use in another machine. Here, the database may be embodied using the memory 170, a memory 230 of the server 200, a memory maintained in a cloud computing environment, or another remote memory position to be accessed using a communication method such as a network.

Information stored in the learning processor 150 may be used by the processor 190 or one or more controllers using any one of various different types of data analysis algorithms and machine learning algorithms.

Examples of such algorithms may include a k-nearest-neighbor system, fuzzy logic (for example, possibility theory), a neural network, a Boltzmann machine, vector quantization, a pulse neural network, a support vector machine, a maximum margin classifier, hill climbing, an inductive logic system, a Bayesian network, a Petri net (for example, a finite state machine, a Mealy machine, or a Moore finite state machine), a classifier tree (for example, a perceptron tree, a support vector tree, a Markov tree, a decision making tree forest, or a random forest), a reading model and system, artificial fusion, sensor fusion, image fusion, reinforcement learning, augmented reality, pattern recognition, and automated planning.

The display 109 may display a cooking procedure through the cooking apparatus 100.

The user input interface 103 may receive a cooking code corresponding to setting of various parameters required to drive the cooking apparatus 100 and a recipe. For example, when a cooking code corresponding to a corresponding recipe of a specific cooking target is displayed, a user may directly input the corresponding cooking code through the user input interface 103 of the cooking apparatus 100.

The processor 190 may control components of the cooking apparatus 100, and may control driving of the cooking apparatus 100 using the components.

In detail, the processor 190 may be determined using data analysis and a machine learning algorithm, or may determine or predict an operation for executing the cooking apparatus 100 based on the generated information. To this end, the processor 190 may request, search for, receive, or use data of the learning processor 150, and may control the cooking apparatus 100 to execute a predicted operation or an operation determined to be appropriate among at least one executable operation.

The processor 190 may perform various functions for embodying emulation (i.e., knowledge-based systems, inference systems, and knowledge acquisition systems). This may be applied to various types of systems (for example, a fuzzy logic system) including, for example, an adaptive system, a machine learning system, and an artificial neural network.

The processor 190 may include a sub module for enabling calculation accompanied with speech and natural language speech processing, such as an I/O processing module, an environment condition module, a speech-to-text processing module, a natural language processing module, a workflow processing module, and a service processing module.

Each of the sub modules may have access to one or more systems or data and model of the cooking apparatus 100, or a subset or superset thereof. Each of the sub modules may provide various functions as well as a glossarial index, user data, a workflow model, a service model, and an automatic speech recognition (ASR) system.

In some embodiments, based on the data of the learning processor 150, the processor 190 may be configured to detect and sense requirements based on contextual conditions expressed by user input or natural language input or an intention of the user.

The processor 190 may actively derive and obtain information required to completely determine the requirement based on the contextual conditions or the intention of the user. For example, the processor 190 may analyze past data including historical input and output, pattern matching, an unambiguous word, input intention, and so on to determine requirements, and in this case, may actively derive the required information.

The processor 190 may determine task flow for executing a function responding to requirements based on the contextual conditions or the intention of the user.

In order to collect information for processing and storage in the learning processor 150, the processor 190 may be configured to collect, sense, extract, detect, and/or receive a signal or data used in a data analysis and machine learning operation through one or more sensing components in the cooking apparatus 100.

The information collection may include sensing information by a sensor, extracting of information stored in the memory 170, or receiving information from other equipment, an entity, or an external storage device through a transceiver.

The processor 190 may collect use history information using the cooking apparatus 100 and may store the use history information in the memory 170. The best match for executing a specific function may be determined using the stored use history information and predictive modeling.

The processor 190 may receive or sense surrounding environment information or other information through the vibration sensor 130, and may receive a broadcast signal and/or broadcast related information, a wireless signal, and wireless data through the transceiver 110. The processor 190 may receive image information (or a corresponding signal), audio information (or a corresponding signal), data, or user input information from the camera 120.

That is, the processor 190 may collect information in real time, may process or classify the information (for example, a knowledge graph, a command strategy, a personalized database, or a conversation engine), and may store the processed information in the memory 170 or the learning processor 150.

When an operation of the cooking apparatus 100 is determined based on data analysis and a machine learning algorithm and technology, the processor 190 may control components of the cooking apparatus 100 in order to execute the determined operation. Further, the processor 190 may control the equipment in accordance with the control command to perform the determined operation.

When performing a specific operation, the processor 190 may analyze history information indicating executing of the specific operation through data analysis and a machine learning algorithm and scheme, and may update previously trained information based on the analyzed information.

Thus, the processor 190, together with the learning processor 150, may enhance future performance of data analysis and a machine learning algorithm and scheme based on the updated information.

The memory 170 may store the recipe received from the server 200, and may store a program corresponding to each recipe.

The memory 170 may also store a cooking time of the cooking target that has been inputted by a user through the user input interface 103. Specifically, the user may input a cooking time of 4 minutes to cook a prepared food that only requires a cooking time of 3 minutes, and such cooking methods are stored in the memory 170. Accordingly, even if the user does not separately input information, it is possible to automatically cook a related product according to user preference.

To this end, the memory 170 may also store personal information of a user who uses the cooking apparatus 100. The personal information of the user may be, for example, fingerprint, facial, or iris information of the user. As the personal information of the user is stored, the cooking target may be cooked according to user preference.

The memory 170 may store data for supporting various functions of the cooking apparatus 100.

In detail, the memory 170 may store a plurality of application programs (or applications) driven in the cooking apparatus 100, data for an operation of the cooking apparatus 100, commands, and data for an operation of the learning processor 150 (for example, at least one piece of algorithm information for machine learning).

The memory 170 may store a model trained by the learning processor 150 or the like. If necessary, the memory 170 may store the learning model by dividing the model into a plurality of versions depending on a training timing or a training progress.

The memory 170 may store, for example, input data acquired by the camera 120, learning data (or training data) used for model learning, and a learning history of a model.

The input data stored in the memory 170 may itself be unprocessed input data, or may be data that has been processed appropriately for model learning.

The memory 170 will now be described in more detail. Various computer program modules may be loaded in the memory 170. The computer programs loaded in the memory 170 may include a recognition module 171, a database (DB) module 172, an AI module 173, a learning module 174, a cooking instruction module 175, and a driving module 176 as an application program as well as a system program for managing an operating system and hardware. Here, some of application programs may be implemented as hardware including an integrated circuit.

The processor 190 may be set to control each of the modules 171 to 176 stored in the memory 170, and the application programs of the respective modules may perform corresponding functions according to the setting. The modules may be set to include a command related to each function of the cooking apparatus control method according to an embodiment of the present disclosure. Various logic circuits included in the processor 190 may read commands of various modules loaded in the memory 170, and functions of the respective modules may be performed to drive the cooking apparatus 100 during an execution procedure.

In detail, the recognition module 171 may search input images for characteristics of a packaging design of a cooking target, a prepared food, or the like depending on a type of the cooking target, and based on the search result may perform a function of recognizing the cooking target. Various algorithms may be applied in detecting the cooking target. Examples of the algorithms may include various recognition methods of comparing an input image with reference images stored in a database based on the outward characteristics of the cooking target, and determining whether the input image matches a reference image.

In the cooking apparatus control method according to an embodiment of the present disclosure, the recognition module 171 may use various pre-processing methods for recognizing a cooking target, and for example, may use conversion of RGB images to Gray and Morph Gradient algorithms to extract a boundary image, and may use Adaptive Threshold algorithms to remove noise. The processor 190 may perform, for example, object detection or optical character recognition (OCR) based on an image captured by photographing the cooking target positioned in the cooking apparatus 100.

In this case, a contour extraction method may be used to recognize an object and a character. Further, the Morph close algorithm and a long line remove algorithm may be used as a method for processing a contour.

The cooking apparatus 100 may recognize the cooking target using the AI module 173, for example, an artificial neural network. For example, an image including the characteristics of the cooking target learned using a sliding window may be searched for by an artificial neural network from a black-and-white still image. It may be possible to extract characteristics of two or more cooking targets. A learning device may train the artificial neural network, as training for image classification and object and character recognition. Image data including only characters and image data including both characters and objects may be prepared as learning data.

There is a method of recognizing a face using a fuzzy and artificial neural network. As an input of the artificial neural network circuit, a fuzzy membership function is used instead of a brightness of a pixel. Performance of this algorithm is improved in comparison to a method only using an artificial neural network, but there is a disadvantage in that the processing speed is slow. According to an embodiment of the present disclosure, the DB module 172 detects a recipe regarding a recognized cooking target. A database of recipes may be provided by the server 200, and the cooking apparatus 100 may store recipe information received by the server 200.

The DB module 172 may update the database using a cooking history and collected log data by the cooking apparatus 100.

As described above, the cooking apparatus 100 may include the AI module 173. The AI model 173 may be implemented by an artificial neural network which is trained to recognize a cooking target through machine learning. The trained artificial neural network may be trained to determine a category to which a cooking target in an input image belongs, among categories including a convenience food, a meal kit, and an unprocessed cooking target according to a processing degree. This training corresponds to image classification by supervised learning.

For example, the artificial neural network may recognize a product name represented on a packaging, a photograph, or an illustration of the product, and classify the recognized object as a convenience food. The artificial neural network may classify a cooking target with a packaging on which only a product name is represented, without a photograph or an illustration of a product, as a meal kit. When a partially wrapped object is recognized, the artificial neural network may also recognize a natural food material that is not processed with respect to another object without a packaging, and may classify the object as an unprocessed cooking target. According to an embodiment, the AI module 173 may be completed via a learning procedure and an evaluation procedure by the server 200, which is a learning device, and then may be stored in the memory 170 of the cooking apparatus.

The stored AI module 173 may be trained as a personalized AI model by a secondary learning procedure by the learning module 174 using user log data collected by the cooking apparatus 100. Thus, a type of a cooking target that is regularly used by a user, and main cooking patterns, may be recognized through secondary learning using the characteristics of an image collected through the camera 120. The cooking instruction module 175 generates a cooking instruction in accordance with the recipe detected from the DB and the cooking pattern recognized by the AI.

When the cooking instruction corresponding to the recognized cooking target is stored in the memory 170 of the cooking apparatus 100, the stored cooking instruction may be used. However, when there is no stored cooking instruction or the stored cooking instruction needs to be modified according to the cooking pattern, the cooking instruction module 175 may generate a new cooking instruction by combining one or more operation instructions. The cooking apparatus 100 may be controlled to cook the corresponding cooking target according to the programmed cooking instruction.

The driving module 176 may drive various cooking apparatuses, for example, an electric oven or a microwave according to a cooking instruction.

A procedure of cooking a cooking target by the cooking apparatus 100 as configured above will now be described. First, the cooking target positioned in the main body 105 of the cooking apparatus 100 may be photographed and recognized using the camera 120.

Then, a position of the cooking target positioned in the main body 105 may be recognized. That is, whether the cooking target is offset to one side rather than being positioned at the center of the cradle 107 of the main body 105 may be recognized.

In this case, a position of the cooking target positioned in the main body 105 may be determined based on an image of the cooking target photographed in the main body 105 using a convolutional neural network of the learning processor 150.

When the position of the cooking target is recognized and then the position of the cooking target deviates from a correct position, a direction of an energy source for cooking the cooking target may be adjusted using the energy direction controller 160.

Thus, even if the position of the cooking target is not the correct position, the cooking target may be appropriately cooked.

During cooking of the cooking target, vibration may occur in the main body 105. The container accommodating the cooking target may move as the cooking target is cooked and heated, due to the frictional sound generated between movement of the container and the cradle 107 of the main body 105.

With regard to the vibration, the state of the cooking target may be estimated according to time-series variation in vibration that occurs during cooking of the cooking target, through the LSTM recurrent neural network of the learning processor 150.

That is, when the cooking target is heated, movement of the container may increase, and the frictional sound between the container and the cradle 107 of the main body 105 may be increasingly generated. That is, when the level of the frictional sound is greater than a predetermined threshold value, the cooking target may be determined to be boiling, and in this case, the intensity of the heater 140 may be controlled to prevent the cooking target from additionally boiling and to prevent the cooking target from escaping the container and contaminating an internal part of the main body 105.

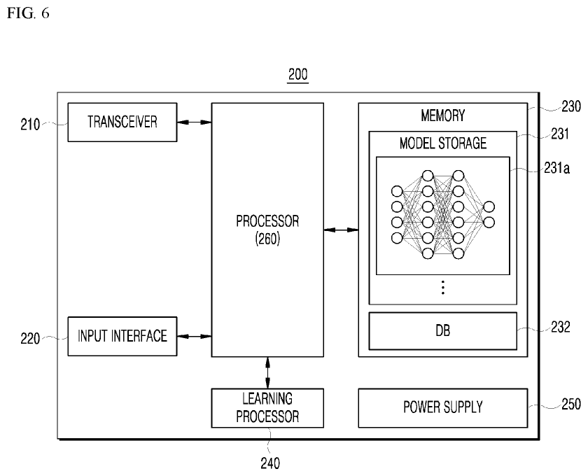

FIG. 6 is a block diagram of a server corresponding to a learning device of an Al model according to an embodiment of the present disclosure.

Referring to FIG. 6, the server 200 may provide training data required to train an AI model for recognizing a cooking target as a learning result, and a computer program related to various AI algorithms, for example, an application programming interface (API), or data workflows, to the cooking apparatus.

The server 200 may collect the training data required for training related to object recognition, character recognition, and recognition of shape characteristics of a food material, in the form of user log data through user data, and may also provide the cooking apparatus 100 with an AI model that is directly trained using the collected training data.

The server 200 may be a device or a server that is separately configured outside the cooking apparatus 100, and may perform the same function as the learning processor 150 of the cooking apparatus 100. That is, the server 200 may be configured to receive, classify, store, and output information to be used for data mining, data analysis, intelligent decision making, and machine learning algorithms. Here, the machine learning algorithm may include a deep learning algorithm.

The server 200 may communicate with at least one cooking apparatus 100, and may analyze or learn data on behalf of the cooking apparatus 100 or by assisting the cooking apparatus 100 to derive the result. Here, “assisting” another device may refer to distribution of computing power by means of distributed processing.

The server 200 of the artificial neural network, which refers to various devices for learning an artificial neural network, may normally refer to a server, and may also be referred to as a learning device or a learning server.

In particular, the server 200 may be implemented as not only a single server, but also a combination of a plurality of server sets, a cloud server, or combinations thereof. That is, the server 200 is configured as a plurality of learning devices to configure a learning device set (or a cloud server) and at least one server 200 included in the learning device set may derive a result by analyzing or learning the data through the distributed processing.

The server 200 may transmit a model trained by machine learning or deep learning to the cooking apparatus 100 periodically or upon request.

The server 200 may include a transceiver 210, an input interface 220, a memory 230, a learning processor 240, a power supply 250, and a processor 260.

The transceiver 210 may correspond to a configuration including the wireless transceiver 110 and the interface 260 of FIG. 2. That is, the transceiver may transmit and receive data with other devices through wired/wireless communication or an interface.

The input interface 220 may be a component corresponding to the camera 120 of the cooking apparatus 100, and may receive data through the transceiver 210 to obtain data. In addition, the input interface 220 may obtain input data for acquiring an output using training data for model learning and a trained model.

The memory 230 may be a device corresponding to the memory 170 of the cooking apparatus 100, and may include a model storage 231 and a database 232.

The model storage 231 stores a model (or an artificial neural network 231a) which is being trained or has been trained through the learning processor 240, and when the model is updated through the training, stores the updated model.

The artificial neural network 231a may be implemented as hardware, software, or a combination of hardware and software. When a part or the entire artificial neural network 231a is implemented by software, one or more commands which configure the artificial neural network 231a may be stored in the memory 230.

The database 232 stores input data obtained from the input interface 220, learning data (or training data) used to train a model, a learning history of the model, and so forth. That is, the input data stored in the database 232 may not only be data which is processed to be suitable for model training, but may also itself be unprocessed input data.

The learning processor 240 may be a component corresponding to the learning processor 150 of the cooking apparatus 100.

In detail, the learning processor 240 of the server 200 may train the artificial neural network 231a using training data or a training set.

The learning processor 240 may immediately obtain data which is obtained by pre-processing input data obtained by the processor 260 through the input interface 220 to train the artificial neural network 231a, or obtain the pre-processed input data stored in the database 232 to train the artificial neural network 231a.

More specifically, the learning processor 240 repeatedly trains the artificial neural network 231a using various training schemes previously described to determine optimized model parameters of the artificial neural network 231a.

The power supply 250 may be a component for supplying power to the server 200.

In addition, the server 200 may evaluate an AI model, and after the evaluation, the server 200 may also update the AI model for enhanced performance and provide the updated AI model to the cooking apparatus 100. Here, the cooking apparatus 100 may perform a series of operations performed by the server 200 alone or through communication with the server 200 in a local region. For example, the cooking apparatus 100 may teach the AI model a personal pattern of the user through training with the user's personal data, and thereby update the AI model which is downloaded from the server 200.

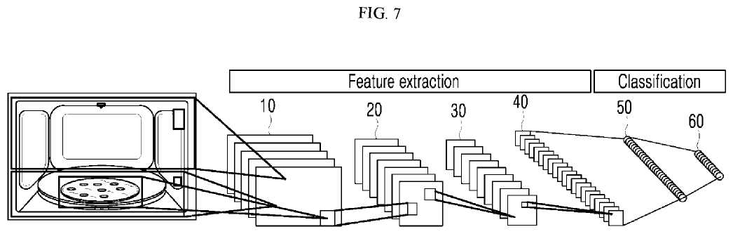

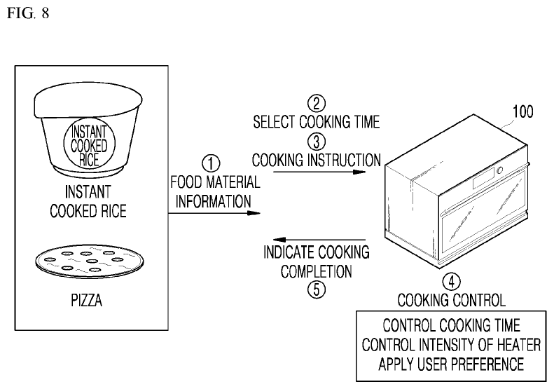

FIG. 7 is a diagram illustrating an example of recognition of a cooking target using an AI model according to an embodiment of the present disclosure. FIG. 8 is a diagram illustrating an example of use of a cooking procedure according to an embodiment of the present disclosure.

FIGS. 7 and 8 illustrate the structure of a convolutional neural network (CNN) that performs machine learning.

The CNN may be divided into an area where a feature of the image is extracted and an area where the class is classified. The feature extracting area is configured by stacking a plurality of convolution layers 10 and 30 and a plurality of pooling layers 20 and 40. The convolution layers 10 and 30 are essential components which reflect an activation function after applying a filter to the input data. The pooling layers 20 and 40 which are located next to the convolution layers 10 and 30 are selective layers. A fully connected layer 60 for image classification may be added to the last part of the CNN. A flatten layer 50 which changes the image shape into an arranged shape is located between a portion of extracting a feature of the image and an area which classifies the image.

The CNN calculates a convolution while a filter circulates the input data for extraction of the feature of the image, and creates a feature map using the calculating result. A shape of the output data is changed in accordance with a size of a convolution layer filter, a stride, whether to apply padding, or a max pooling size.

When the cooking target corresponds to a product such as a convenience food or a prepared food, the cooking apparatus 100 may display, for example, expiration date information and recipe information of the cooking target.

When the cooking target includes an unprocessed cooking target, the cooking apparatus 100 may receive cooking target information from the user (\textcircled{1} of FIG. 8).

According to an embodiment of the present disclosure, the cooking target information may refer to information that is capable of substituting or replacing recognition of the cooking target. The cooking target information may include various codes represented on the cooking target, for example, a barcode, a QR code, a food name inputted by a user, a name of the cooking target, or a code corresponding thereto. Thus, when the cooking target is recognized, corresponding cooking target information may also be additionally inputted with respect to an additional cooking target.

The cooking apparatus 100 may detect a corresponding recipe based on, for example, the cooking target and the cooking target information. For example, in the case of instant cooked rice, which is a prepared food, the cooking apparatus 100 may detect a recipe for cooking the instant cooked rice, which is stored in a QR code, a barcode, or the like of the instant cooked rice. In contrast, when an already-cooked food is frozen and is then cooked (for example, pizza), the cooking apparatus 100 may detect a recipe for cooking the frozen food, stored in the cooking apparatus 100 and/or the server 200 (\textcircled{2} of FIG. 8).

When the recipe is detected, a cooking instruction may be executed (\textcircled{3} of FIG. 8). In this case, the cooking instruction may automatically drive the cooking apparatus 100 according to the detected recipe to cook the cooking target, but in contrast, the user may input the recipe through the user input interface 103 of the cooking apparatus 100 to execute the cooking instruction. In addition, cooking items according to the recipe may be displayed on the display 109 of the cooking apparatus 100, and the user may select the cooking items displayed on the display 109 to execute the cooking instruction.

In this case, the cooking apparatus 100 may control the cooking apparatus 100 to control cooking of a food according to the cooking instruction of the user (\textcircled{4} of FIG. 8).

For example, when the frozen pizza is put into the cooking apparatus 100, the frozen pizza may be offset in one direction of right and left or forward and backward directions, and not positioned in the center of the inside of the cooking apparatus 100. In such a case, if heat emitted toward the frozen pizza from the heater s constant, the portion of the food that is offset to one side may be less cooked.

Thus, when the position of the frozen pizza is recognized through the camera 120, and the position of the frozen pizza is offset to one side, heat emitted from the heater may be emitted to correspond to the position of the offset frozen pizza to appropriately cook the frozen pizza.

Similarly, the cooking state of the cooking target may be extracted through the camera 120, and a cooking time may be controlled. For example, even if the cooking time for cooking the frozen pizza is detected as 3 minutes, the surface of the pizza may boil after 2 minutes of cooking. In this case, cooking may be stopped after 2 minutes, thereby preventing the cooking target from being additionally cooked and not possible to eat.

In contrast, even if the cooking time for cooking the frozen pizza is detected as 3 minutes, the user may execute the cooking instruction of the frozen pizza for 4 minutes. In this case, once the cooking instruction of the frozen pizza of the user has been stored and the user then puts in the frozen pizza again, the frozen pizza may be automatically cooked for 4 minutes, which is preferred by the user. That is, the preference of the user according to the cooking target may be applied.

As such, cooking may be controlled to indicate that cooking is completed when the cooking target is completely cooked ((5) of FIG. 8). In this case, completion of cooking may be indicated through an alarm service of the cooking apparatus 100, or the equipment 300 that is connected to the cooking apparatus 100 and communicates therewith.

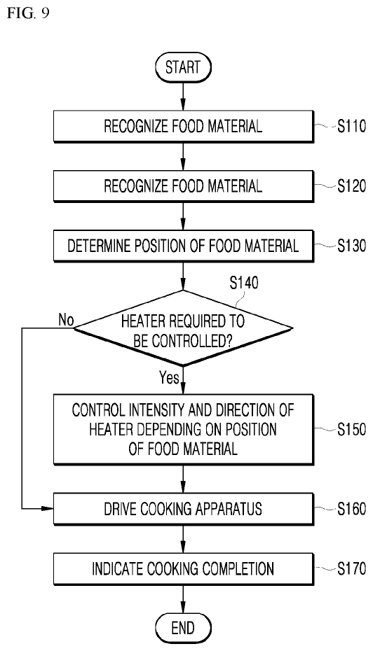

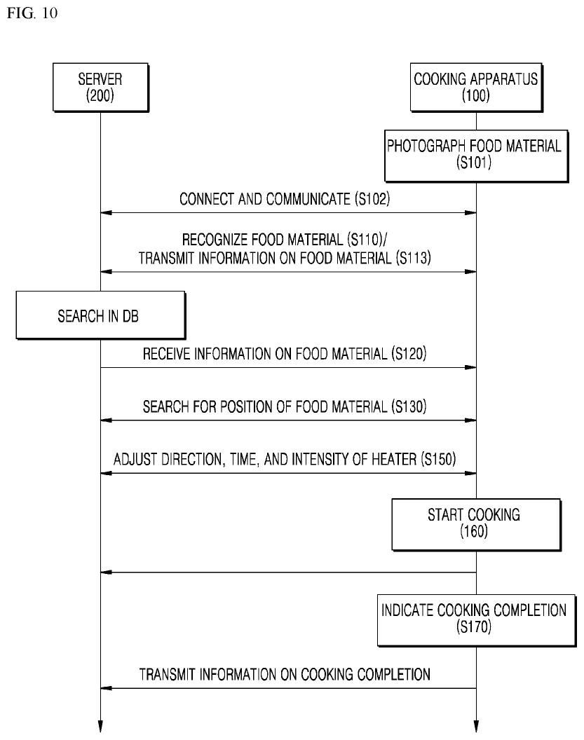

FIG. 9 is a flowchart of a cooking apparatus control method according to an embodiment of the present disclosure. FIG. 10 is a flowchart of data of a cooking apparatus control method according to an embodiment of the present disclosure.

Referring to FIGS. 9 and 10, the cooking apparatus 100 according to an embodiment of the present disclosure may be configured to perform operations S110 to S170. Each operation may be performed by the cooking apparatus 100 alone or by the cooking apparatus 100 in conjunction with the server 200. Hereinafter, the present disclosure will be described with reference to the drawings.

Here, a subject for performing each operation included in the cooking apparatus control method may be any one of the cooking apparatus 100 and the equipment 300, but in detail, each operation may be performed by the processor 190 of the cooking apparatus 100 that executes a computer command including a program stored in the memory 170 of the cooking apparatus 100.

The processor 190 may be implemented by at least one of a central processing unit (CPU) or a graphics processing unit (GPU). Hereinafter, each operation will be described in terms of the cooking apparatus 100 or the processor 190 that is a subject for performing the cooking apparatus control method according to an embodiment of the present disclosure.

The cooking apparatus 100 may photograph the cooking target in the cooking apparatus 100 through the camera 120 that is inside or outside the cooking apparatus 100, and then may recognize an image captured by photographing the cooking target to receive information on the cooking target (S101 and S110). The present step may be configured to include obtaining the image of the cooking target, removing noise from the obtained image, training an AI model using the image from which noise has been removed as learning data, and recognizing an object, that is, the cooking target, using the AI model that is completely trained through evaluation.

The removal of the noise corresponds to a data mining step to increase the learning effect of the AI model. As described above, the step of removing noise may be configured to include a step of converting the image from an RGB mode to a gray mode, a step of extracting a contour image using the Morph gradient algorithm, a step of removing noise using an adaptive threshold algorithm, a step of optimizing the image using Morph close and long line remove algorithms, and a step of extracting a contour. However, the name of the algorithm used for the noise removing process is merely for exemplary purposes in describing an embodiment of the present disclosure, and does not exclude the use of other algorithms.

In the present step, when the cooking target is photographed, the server 200 and the cooking apparatus 100 may be connected to communicate with each other, may transmit information on the photographed cooking target through the server 200, and may receive related information on the cooking target (S102, S113, and S120).

In an embodiment of the present disclosure, recognition of the cooking target may be performed in two steps. That is, recognition of the cooking target may be configured to include determining a category to which a cooking target, for example, a convenience food, a prepared food such as a meal kit, and an unprocessed cooking target, belongs, and recognizing an ID of a product based on a packaging design of the corresponding category (for example, a prepared food) or recognizing an object of an unprocessed cooking target. However, in the case of prepared food, the above two steps may be simultaneously performed, and thus the ID of the product may also be immediately recognized using an object image and text represented on the packaging design of the product.

The recognition of the unprocessed cooking target may be based on recognition of an object in an image, and may include recognition of a plurality of cooking targets. The recognition of the plurality of cooking targets may include recognition of a product with a brand represented thereon. According to an embodiment of the present disclosure, a recognition procedure of recognizing a cooking target using an AI model may be performed. Specifically, image classification, object recognition, and character recognition processes may be performed using the artificial neural network which performs machine learning.

According to an embodiment of the present disclosure, when the cooking target is put into the cooking apparatus 100, a position of the cooking target may be searched for (S130). That is, an automatic cooking neural network may be selected depending on the cooking target and the position of the cooking target.

Here, the automatic cooking neural network may enable cooking depending on the aforementioned cooking target type, and the food cooking state. When the cooking target is not positioned at a correct position (for example, the center of the inside of a main body of the cooking apparatus), the automatic cooking neural network may automatically adjust a heater for heating the cooking target to appropriately cook the cooking target.

In detail, when information on a food material is received, if the cooking target is a prepared food, a position of the food positioned in the cooking apparatus 100 may be recognized (S140). When the recognized position of the food is not the correct position, the food may not be uniformly cooked if heat emitted from the heater is emitted to the center of the inside of the cooking apparatus 100. To prevent this, an emission direction of the heater may be controlled to allow the heat emitted from the heater to reach an overall portion of the food (S150). That is, a direction of the heater for heating the cooking target may be controlled depending on the position of the cooking target through the neural network for recognizing an image of a cooking target.

For example, when a prepared food is put into the cooking apparatus 100, information on a recipe, such as a recommended cooking time of the food, may be extracted from a QR code, a bar code, or the like printed on a packaging of the prepared food. The cooking apparatus 100 may be driven based on the extracted recipe information to cook the food.

In contrast, even if the cooking target is not an unprocessed product, a position of the cooking target in the cooking apparatus 100 may be determined, and the heater may be controlled depending on the position of the cooking target.

Here, the control of the heater may refer to adjustment of, for example, an emission time and intensity of the heater for heating the cooking target, in addition to a direction of the heater for heating the cooking target.

When the heater is controlled to cook the cooking target and then completes cooking, whether cooking is completed may be outputted through an alarm service installed in the cooking apparatus 100, or alternatively, related information may be transmitted to the equipment 300 that is connected to the cooking apparatus 100, and thus the user may recognize completion of cooking of the food (S109 and S170).

In this case, the cooking apparatus 100 may transmit information on a time for cooking the cooking target and the intensity of the heater to the server 200. The server 200 may store information on, for example, a product for each food material, a cooking time for the material, and an intensity of the heater for cooking.

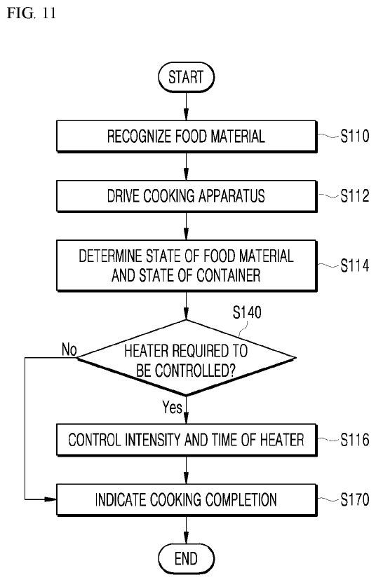

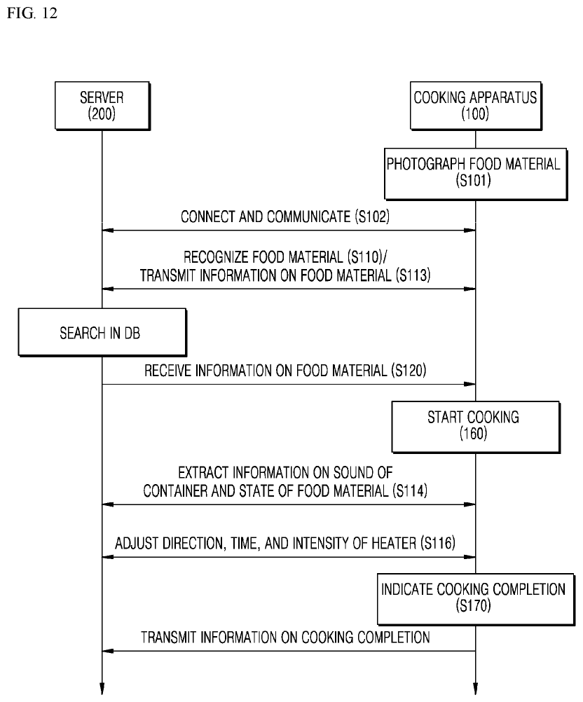

FIG. 11 is a flowchart of a cooking apparatus control method according to another embodiment of the present disclosure. FIG. 12 is a flowchart of data of a cooking apparatus control method according to another embodiment of the present disclosure.

Referring to FIGS. 11 and 12, FIG. 11 is different from FIG. 9 in that the cooking target is put into to the cooking apparatus 100 and the cooking apparatus 100 is driven to control the heater through the state of the cooking target photographed by the camera 120 during a procedure of cooking the cooking target.

In detail, the cooking apparatus 100 may photograph the cooking target in the cooking apparatus 100 through the camera 120 that is installed inside or outside the cooking apparatus 100, and then may recognize an image of the photographed cooking target to receive information on the cooking target (S110).

Then, the cooking apparatus 100 may be driven to cook the cooking target, and may determine, for example, the state of the cooking target or the state of the container accommodating the cooking target through the camera 120 installed inside or outside the cooking apparatus 100, during a procedure of cooking the cooking target (S112 and S114).

As described above, a microwave, which is the cooking apparatus 100 according to an embodiment of the present disclosure, is a device for cooking a food by intensively emitting electromagnetic waves to food containing moisture, and applying vibration to the moisture inside the food to heat the food. Thus, when the heater emits heat to the cooking target for a predetermined time or greater or with a predetermined intensity or greater, the cooking target may boil. In this case, the container accommodating the cooking target may be heated by heat generated inside the cooking apparatus, and the cooking target may spill over the container. When the container is heated, the container may lightly shake, and vibration (frictional sound) may be generated between the container and an internal bottom surface of the cooking apparatus due to the shaking of the container.

The state of the cooking target or the state of the container may be checked through the camera 120, and upon a determination that the heater is required to be controlled, the intensity and time of the heater may be controlled to prevent the cooking target from being damaged by the heater or from spilling over the container (S114 and S116).

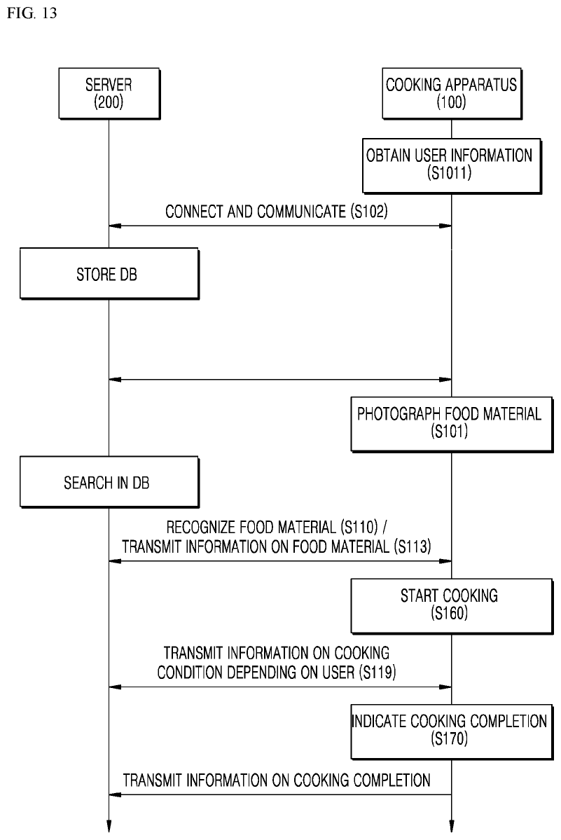

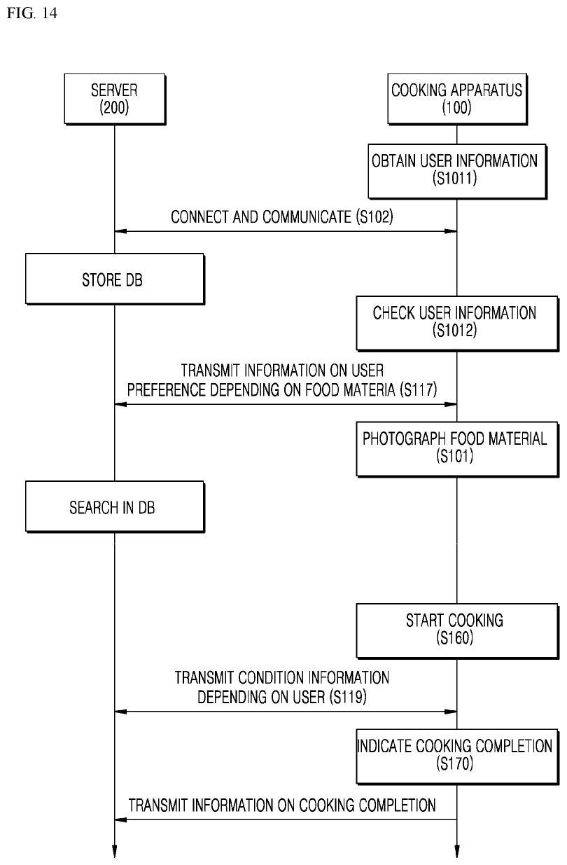

FIGS. 13 and 14 are flowcharts of data of a cooking apparatus control method according to another embodiment of the present disclosure.

Referring to FIGS. 13 and 14, FIG. 13 is different from FIGS. 9 and 11 in that the cooking target is cooked based on personal information of a user who uses the cooking apparatus 100.

In detail, the cooking apparatus 100 may be controlled according to personal information of a user who uses the cooking apparatus 100, for example, fingerprint information of the user or food preference information of the user depending on the food.

To this end, the personal information of the user who uses the cooking apparatus 100 may be obtained first. Here, the personal information of the user may refer to biometrics, such as the iris or fingerprint, of the user. The obtained personal information of the user may be a reference for selecting a cooking condition of the cooking target, which will be described below (S1011).

After the personal information of the user is obtained, the cooking target in the cooking apparatus 100 may be photographed through the camera 120 installed inside or outside the cooking apparatus 100, and an image of the photographed cooking target may then be recognized and information on the cooking target may be received.

Then, in the case of a prepared food according to information on the cooking target, cooking may be performed according to a pre-stored recipe based on a packaging design. In contrast, in the case of an unprocessed cooking target, cooking may be performed based on input information inputted by the user.

The cooking condition may be stored in the server 200. The cooking condition stored in the server 200 may be data for automatically cooking the cooking target when the same user cooks the same cooking target using the cooking apparatus 100 (S115).

For example, according to his or her preference, the user may change the cooking method of the prepared food. For example, a recommended cooking time of the frozen pizza may be 3 minutes, but the user may cook the frozen pizza for 4 minutes.

A procedure in which the cooking condition of the user has been stored in the server 200. and the user then uses the cooking apparatus 100 in the state in which the user information has been stored, will be described below with reference to FIG. 13.

First, in the state in which the user information has been stored, the user may turn on the cooking apparatus 100 or may open the cooking apparatus 100. In this case, the user information stored in the server 200 may be checked, and when the checked user information is determined to correspond to the user who is driving the cooking apparatus 100, the cooking target that user is putting into the cooking apparatus 100 may be recognized.

Then, the cooking condition of the user depending on the recognized cooking target may be transmitted to the cooking apparatus 100 (S117). That is, the cooking condition of the past cooking history may be transmitted to the memory 170 of the cooking apparatus 100.

The cooking target is then cooked based on the transmitted cooking condition of the user, and upon completion of the cooking, information on cooking completion may be transmitted to the server 200 (S119).

Here, when the user changes the cooking condition of the cooking target, the changed cooking condition may be re-transmitted to the server 200, and the server 200 may update a date of transmitting the cooking condition transmitted from the cooking apparatus 100 based on the recent date. This is based on an assumption that, when cooking the same cooking target in the future, users prefer the cooking condition that was used at the most recent date.

As such, the cooking target may be recognized through the cooking apparatus and the cooking apparatus control method according to various embodiments of the present disclosure, and a direction of the heater for heating the cooking target may be controlled depending on the position of the recognized cooking target.

In particular, during cooking of the cooking target, even if the position of the cooking target in the cooking apparatus is not a correct position, the cooking target may be appropriately cooked. In detail, the position of the cooking target may not be positioned at a cooking position inside the cooking apparatus. In this case, after the position of the cooking target is determined, the direction of the heater for cooking the cooking target may be controlled to emit heat emitted from the heater to an overall portion of the cooking target, and thus the cooking target may be uniformly cooked.

In addition, according to the embodiments of the present disclosure, the cooking target may be classified into a prepared food (a convenience food and a meal kit) and an unprocessed cooking target. Here, in the case of the prepared food, a recipe of a product may be extracted through a QR code, a bar code, or the like loaded on a product packaging, and the product may be cooked based on the extracted recipe of the product.

In addition, the heater may be controlled through the state of the cooking target photographed by a camera during a procedure of driving the cooking apparatus to cook the cooking target. In detail, the cooking target may be cooked by the heater for heating the cooking target by the cooking apparatus. In this case, when the cooking target contains moisture, if heat emitted from the heater is emitted to the cooking target for a predetermined time or greater or with a predetermined intensity or greater, the cooking target may boil. In this case, the container accommodating the cooking target may also be heated by heat generated inside the cooking apparatus, and the cooking target may spill over the container. When the container is heated, the container may lightly shake, and frictional sound may be generated between the container and an internal bottom surface of the cooking apparatus due to the shaking of the container. The cooking target may be determined to be boiling through the generated frictional sound, and when the cooking target is boiling, the intensity, time, or the like of the heater for heating the cooking target may be adjusted to prevent the cooking target from spilling over the container.

The example embodiments described above may be implemented through computer programs executable through various components on a computer, and such computer programs may be recorded in computer-readable media. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

The computer programs may be those specially designed and constructed for the purposes of the present disclosure or they may be of the kind well known and available to those skilled in the computer software arts. Examples of computer programs may include both machine codes, such as produced by a compiler, and higher-level codes that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and therefore, the disclosed numeral ranges include every individual value between the minimum and maximum values of the numeral ranges.

Also, the order of individual steps in process claims of the present disclosure does not imply that the steps must be performed in this order; rather, the steps may be performed in any suitable order, unless expressly indicated otherwise. In other words, the present disclosure is not necessarily limited to the order in which the individual steps are recited. Also, the steps included in the methods according to the present disclosure may be performed through the processor or modules for performing the functions of the step. All examples described herein or the terms indicative thereof (“for example,” etc.) used herein are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various modifications, combinations, and alternations can be made depending on design conditions and factors within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. A cooking apparatus using image analysis artificial intelligence (AI) technology, comprising:
a main body that forms an exterior of the cooking apparatus;
a heater configured to cook a cooking target in the main body;
a camera configured to photograph the cooking target; and
a processor configured to communicate with the camera and the heater to control the cooking apparatus,
wherein the processor is configured to recognize a position of the cooking target photographed by the camera in the main body, and control the heater depending on the position of the cooking target.

2. The cooking apparatus of claim 1, wherein the heater comprises:
an energy source configured to provide energy for heating the cooking target; and
an energy direction controller configured to adjust a direction of the energy emitted toward the cooking target from the energy source,
wherein the processor controls the energy direction controller to be directed toward the cooking target photographed by the camera.

3. The cooking apparatus of claim I, further comprising a vibration sensor configured to sense vibration in the main body,
wherein the processor determines a state of the cooking target based on the vibration sensed through the vibration sensor, and controls the heater based on the determination.

4. The cooking apparatus of claim 3, wherein the vibration sensor senses frictional sound between a bottom surface of the main body and a container accommodating the cooking target in the main body during cooking of the cooking target.

5. The cooking apparatus of claim 4, wherein the frictional sound is generated due to movement of the container according to a variation in the state of the cooking target in the container during cooking of the cooking target, and
wherein the processor determines the cooking target to be boiling based on a level of the frictional sound being greater than a predetermined threshold value.

6. The cooking apparatus of claim 1, wherein the processor determines a state of the cooking target by applying an LSTM recurrent neural network to the sensed vibration, and
wherein the LSTM recurrent neural network is a neural network that is pre-trained to estimate the state of the cooking target according to a time-series variation of the vibration generated by the cooking target.

7. The cooking apparatus of claim 1, wherein the processor determines the position of the cooking target in the main body by applying a convolutional neural network to an image of the photographed cooking target; and
wherein the convolutional neural network is a neural network that is pre-trained to determine the position of the cooking target in the main body based on the image of the cooking target photographed in the main body.

8. The cooking apparatus of claim 2, wherein the energy direction controller comprises:
a transmission path comprising a plurality of slots configured to transmit electric energy and a signal generated by the heater to the cooking target; and
a dielectric configured to pass through the plurality of slots to vary a phase of the slot.

9. The cooking apparatus of claim 8, wherein each of the plurality of slots functions as a slot antenna, and the transmission path and the plurality of slots operate as an array antenna; and
wherein the dielectric is changed in position between the slot antennas to vary an emission pattern of the array antenna.

10. A cooking apparatus control method using image analysis artificial intelligence (AI) technology, the method comprising:
photographing a cooking target positioned in a main body that forms an exterior of the cooking apparatus;
recognizing a position of the photographed cooking target in the main body; and
controlling a heater disposed in the main body to heat the cooking target depending on the position of the cooking target.

11. The method of claim 10, wherein the controlling the heater comprises:
generating energy for heating the cooking target through the heater; and
controlling the heater to adjust a direction in which the energy is directed,
wherein the direction in which the energy is directed is directed toward the position of the cooking target in the main body.

12. The method of claim 10, further comprising:
sensing vibration in the main body;
determining a state of the cooking target based on the sensed vibration in the main body; and
controlling the heater depending on the determined state of the cooking target.

13. The method of claim 10, wherein the sensing the vibration in the main body comprises sensing frictional sound between a bottom surface of the main body and a container accommodating the cooking target in the main body during cooking of the cooking target.

14. The method of claim 13, wherein the sensing the frictional sound comprises:
generating the frictional sound due to movement of the container according to a variation in the state of the cooking target in the container during cooking of the cooking target; and
determining the cooking target to be boiling based on a level of the frictional sound being greater than a predetermined threshold value.

15. The method of claim 13, wherein the controlling the heater comprises determining a state of the cooking target by applying an LSTM recurrent neural network to the sensed vibration,
wherein the LSTM recurrent neural network is a neural network that is pre-trained to estimate the state of the cooking target according to a time-series variation of the vibration generated by the cooking target.

16. The method of claim 10, wherein the controlling the heater comprises determining the position of the cooking target in the main body by applying a convolutional neural network to an image of the photographed cooking target,
wherein the convolutional neural network is a neural network that is pre-trained to determine the position of the cooking target in the main body based on the image of the cooking target photographed in the main body.

17. A cooking apparatus, comprising:
at least one processor; and
a memory connected to the processor,
wherein the memory stores an instruction configured to cause the processor to photograph a cooking target positioned in a main body that forms an exterior of the cooking apparatus, recognize a position of the photographed cooking target in the main body, and control a heater for heating the cooking target depending on the position of the cooking target, when the instruction is executed by the one or more processors.
